(19) United States
(12) Patent Application Publication
(10) Pub. No.: US 2026/0331497 A1
(43) Pub. Date: Oct. 22, 2026

(54) COATING FOR NEGATIVE ELECTRODE AND SOLID-STATE BATTERIES COMPRISING SAME

(71) Applicant: Factorial Inc., Billerica, MA (US)

(72) Inventors: Won Seok Chang, Cambridge, MA (US); Takaaki Miki, Malden, MA (US); Hosang Park, Winchester, MA (US); Jae Myung Lee, Belmont, MA (US); Hyun Seok Kim, Lexington, MA (US)

(21) Appl. No.: 19/719,513

(22) Filed: Jun. 25, 2026

Related U.S. Application Data
(63) Continuation-in-part of application No. 18/641,550, filed on Apr. 22, 2024.
(60) Provisional application No. 63/498,545, filed on Apr. 27, 2023.
(60) Provisional application No. 63/517,364, filed on Aug. 3, 2023.

(51) Int. Cl. H01M 4/583; H01M 4/02; H01M 4/04; H01M 10/0562

(52) U.S. Cl. CPC H01M 4/583; H01M 4/0404; H01M 4/0435; H01M 10/0562; H01M 2004/021; H01M 2004/027

(57) ABSTRACT

Disclosed is an anode coating comprising particles of elements A and B and a carbonaceous material, wherein element A is alloyable with lithium and element B is not alloyable with lithium. Methods for preparing the coating and all solid-state battery (ASSB) comprising the same are also disclosed. In one embodiment, ASSB comprising the coating exhibits a reduced charging overpotential and an improved specific capacity and cycle life.

### CROSS-REFERENCE

The present application is a continuation-in-part application of U.S. Ser. No. 18/641,550, filed Apr. 22, 2024, which claims the benefit of U.S. Ser. No. 63/517,364, filed Aug. 3, 2023 and U.S. Ser. No. 63/498,545, filed Apr. 27, 2023, the entire content of which are incorporated herein by reference into this application.

### FIELD

This disclosure relates to a coating comprising particles of element A, particles of element B, and a carbonaceous material, wherein element A is a metal or metalloid alloyable with lithium and element B is not alloyable with lithium. Solid-state batteries comprising the same are also disclosed.

### BACKGROUND

Lithium metal anodes are promising over other types of anodes (such as graphite-based anodes) for use in high energy-density all-solid-state batteries (ASSBs) due to high theoretical capacity of 3,860 mAh/g. However, formation of lithium dendrite may cause safety problems and lead to a short cycle life. It has been shown that a nanocomposite layer of Ag/carbon (alternatively Ag/C) on lithium metal anode can lead to an improved cycle life. Silver nanoparticles are prone to forming agglomerations and may deteriorate the safety issue by accelerating the growth of lithium dendrite. Thus, there remains a need for a new anode design.

### SUMMARY

The present disclosure provides an anode coating (alternatively, protective layer or interlayer) comprising particles of element A, particles of element B, and a carbonaceous material, wherein element A is a metal or metalloid alloyable with lithium, element B is not alloyable with lithium and the particles of elements A and B are uniformed distributed in a matrix comprising the carbonaceous material. In some embodiments, the carbonaceous material is present at a volume percentage of no less than 50% in the coating. Methods for preparing the anode coating and all solid-state battery (ASSB) comprising the same are also disclosed.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 is a schematic diagram showing a coating (1) comprising particles of element A (2), particles of element B (3), and a carbonaceous material (4) on an anode current collector (5) according to one embodiment of the present disclosure.

FIG. 2 is a schematic diagram showing a coating (1) comprising particles of element A (2), particles of element B (3), and a carbonaceous material (4) on an anode active material layer (6) comprising lithium metal according to one embodiment of the present disclosure.

FIG. 3 shows the rate capability of batteries comprising coatings of Reference Example (Ref. Ex.), Comparative Example 1 (Comp. Ex. 1), Comparative Example 2 (Comp. Ex. 2), Comparative Example 3 (Comp. Ex. 3), Example 1 (Ex. 1), Example 2 (Ex. 2), Example 3 (Ex. 3), Example 4 (Ex. 4), Example 5 (Ex. 5), and Example 6 (Ex. 6) according to some embodiments of the present disclosure.

FIG. 4 shows the discharge capacity cycle performance of batteries comprising coatings of Reference Example (Ref. Ex.), Comparative Example 1 (Comp. Ex. 1), Comparative Example 2 (Comp. Ex. 2), Comparative Example 3 (Comp. Ex. 3), Example 4 (Ex. 4) and Example 5 (Ex. 5) according to some embodiments of the present disclosure.

FIG. 5 shows an SEM image of a coating comprising Ag/carbon composite prepared according to Reference Example.

FIG. 6A shows an SEM image of a coating comprising Zn as element A, Cu as element B, and a carbonaceous material according to Ex. 4 (Zn/Cu/carbon, 1.5/3.5/95).

FIG. 6B shows an SEM image of a coating comprising Zn as element A, Cu as element B, and a carbonaceous material according to Ex. 5 (Zn/Cu/carbon, Mar. 7, 1990).

FIG. 6C shows an SEM image of a coating comprising Zn as element A, Cu as element B, and a carbonaceous material according to Ex. 6 (Zn/Cu/carbon, Jun. 14, 1980).

FIG. 6D shows an SEM image of a coating comprising Zn as element A, Cu as element B, and a carbonaceous material according to Ex. 1 (Zn/Cu/carbon, 7.5/17.5/75).

FIG. 7 shows electrochemical impedance spectroscopy (EIS) results of the Reference Example (Ref. Ex.) and Example 4 (Ex. 4) before and after rate capability test.

FIG. 8A shows the specific discharge capacity evolvement in a cycle test of batteries comprising coatings of Examples S1 through S10 according to some embodiments of the present disclosure.

FIG. 8B shows the capacity retention in a cycle test of batteries comprising coatings of Examples S1 through S10 according to some embodiments of the present disclosure.

FIG. 9A shows the capacity in a cycle test of batteries comprising coatings of Examples 5 through 6 according to some embodiments of the present disclosure.

FIG. 9B shows the capacity retention in a cycle test of batteries comprising coatings of Examples 5 through 6 according to some embodiments of the present disclosure.

FIG. 10 shows high c-rate capability half-cell test of Example 5 vs. Ref. Ex. up to 5.5C (1C=170 mAh) according to one embodiment of the present disclosure.

FIG. 11 shows cycle performance half-cell test of Example 5 vs. Ref. Ex. based on 0.33C (1C=170 mAh) according to one embodiment of the present disclosure.

### DETAILED DESCRIPTION

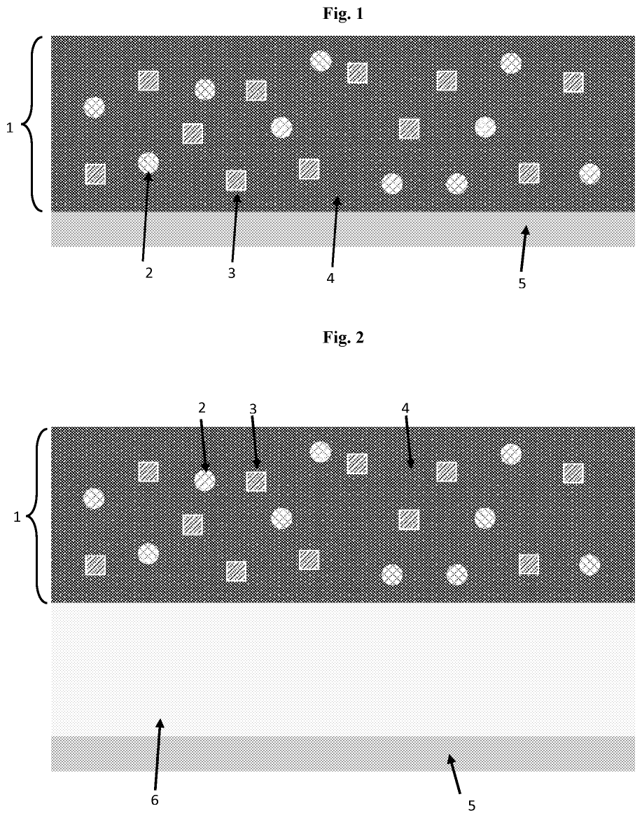

Disclosed herein is a coating that provides desirable cycle life and safety benefits when incorporated into an all-solid state battery (ASSB). In some embodiments, the coating (or alternatively, a layer) includes particles of element A, particles of element B, and a carbonaceous material, wherein element A is a metal or metalloid alloyable with lithium and element B is not alloyable with lithium and wherein the particles of elements A and B are uniformed distributed in a matrix of the carbonaceous material. In some embodiments, the coatings disclosed herein are coatings for an anode layer. In some embodiments, the coatings are interlayers between an anode (negative electrode) layer and an electrolyte layer in an electrochemical device. In some embodiments, the coatings are in direct contact with an anode current collector or an anode active material layer of an anode layer. In some embodiments, an anode layer may comprise an anode current collector without any anode active material layer before first charge. In some embodiments, an anode layer may comprise an anode current collector with an anode active material layer before first charge. As shown for example in FIG. 1, a coating (1) includes particles of element A which is alloyable with lithium (2) and particles of element B which is not alloyable with lithium (3), wherein the particles of elements A and B are uniformly distributed in a matrix of a carbonaceous material (4). Depending on the configuration of a particular all-solid state battery (ASSB), the coating (1) may be disposed on an anode current collector (5) as shown in FIG. 1. In other embodiments, as shown in FIG. 2, the coating (1) may be disposed on an anode active material layer (6), for example a lithium metal, which in turn is disposed on the anode current collector (5). The anode active material layer (6) is formed either before or after the first charge.

In some embodiments, the carbonaceous material comprises at least one selected from the group consisting of carbon fiber, carbon nanotube, carbon wire, natural graphite, artificial graphite, graphene, carbon black, acetylene black, and ketjen black. In some embodiments, the carbonaceous material exhibits in a form selected from the group consisting of nanoparticles, nanoplatelets, nanowires, nanotubes, and a combination thereof. In some embodiments, the nanoparticles, nanoplatelets, nanowires and nanotubes have at least one dimension that is less than or equal to 100 nm. In some embodiments, the carbonaceous material is present at a volume percentage of no less than 50% in the coating.

In some embodiments, element A is chosen for its ability to form an alloy with lithium atoms or ions, thus it is alloyable with lithium. In some embodiments, element A and lithium can form an alloy wherein lithium is present at a weight percentage greater than or equal to 4%, 10%, 15%, 20%, 25%, or 30% in the alloy. In some embodiments, element A and lithium can form an alloy wherein lithium is present at a weight percentage less than or equal to 50%, 40%, 30%, 20%, or 10% in the alloy.

In some embodiments, element A is a metal or metalloid. In some embodiments, element A comprises at least one selected from the group consisting of Ag, Zn, Ti, Cd, Mg, Al, Ga, Si, Ge, In, Sn, Pb, Bi, Sb, and mixtures thereof. In some embodiments, element A does not comprise Ag. In some embodiments, the coating described herein is substantially free of Ag. In some embodiments when the coating is disposed on an anode layer, the particles of element A may migrate or move over time within the carbonaceous material to concentrate or agglomerate to an area adjacent to or even into the anode layer because of the lithium in the anode active material and/or the buildup of lithium at the anode during charging. Too much agglomeration of particles of element A may lead to formation of lithium dendrites and a short circuit of a battery cell, and thus in some embodiments, element A is present at a weight percentage of less than or equal to 17.5% of the coating. In some embodiments, element A is present at a weight percentage in a range from 1% to 17.5%, from 2.5% to 17.5%, from 5% to 17.5%, from 7.5% to 17.5%, from 1% to 15%, from 2% to 15%, from 3% to 15%, from 4% to 15%, from 5% to 15%, from 7.5% to 15%, from 1% to 12.5%, from 2% to 12.5%, from 3% to 12.5%, from 5% to 12.5%, from 7.5% to 12.5%, from 1% to 10%, from 2% to 10%, from 3% to 10%, from 5% to 10%, from 7.5% to 10%, and any and all ranges and subranges therebetween in the coating. In some embodiments, as long as they are capable of alloying with lithium, element A can be elementary substances (such as zinc particles), chemical compounds, or mixtures thereof, such as silicon compound and tin alloys. In some embodiments, silicon compound can be SiOₓ (where 0.5≤x≤1.5). In some embodiments, nonlimiting specific tin alloys include Cu—Sn alloys, Co—Sn alloys and the like. In some embodiments, the coating is free of agglomerations of particles of element A and element B.

In some embodiments, element B is chosen for its ability to not form an alloy with lithium ions or atoms, thus it is not alloyable with lithium. Without being bound by theory, since element B is not alloyable with lithium, the particles of element B do not migrate or agglomerate within the carbonaceous material like element A. In some embodiments, element B has an electrical conductivity greater than that of the carbonaceous material and/or element A, thereby enhancing the electrical conductivity of the coating.

In some embodiments, element B comprises at least one selected from the group consisting of Cu, Mo, Ir, W, Co, Ni, Ru, Fe, Se, Ta, Nb, V, Zr, and mixtures thereof. In some embodiments, particles of element B are present at a weight percentage in a range from 3% to 15% in the coating. In some embodiments, particles of element B are present at a weight percentage in a range from 1% to 17.5%, from 2.5% to 17.5%, from 5% to 17.5%, from 7.5% to 17.5%, from 1% to 15%, from 2% to 15%, from 3% to 15%, from 4% to 15%, from 5% to 15%, from 7.5% to 15%, from 1% to 12.5%, from 2% to 12.5%, from 3% to 12.5%, from 5% to 12.5%, from 7.5% to 12.5%, from 1% to 10%, from 2% to 10%, from 3% to 10%, from 5% to 10%, from 7.5% to 10%, and any and all ranges and subranges therebetween in the coating.

In some embodiments, the electrical conductivity of element B is higher than that of element A to boost the electrical conductivity of the coating. In some embodiments, the ratio of the electrical conductivity of element B to that of element A is in a range from 1 to 30, from 2.5 to 30, from 5 to 30, from 10 to 30, from 1 to 25, from 2.5 to 25, from 5 to 25, from 10 to 25, from 1 to 20, from 2.5 to 20, from 5 to 20, from 10 to 20, from 1 to 15, from 2.5 to 15, from 5 to 15, from 10 to 15, from 1 to 10, from 2.5 to 10, from 5 to 10, and any and all ranges and subranges therebetween. In some embodiments, the ratio of the electrical conductivity of element B to that of element A is less than 1. In some embodiments, the ratio of the electrical conductivity of element B to that of element A is in a range from 0.2 to 1.0, from 0.5 to 1.0, or from 0.75 to 1.0.

In some embodiments, the particles of element A and element B are present at a weight ratio (hereinafter A/B weight ratio) in a range from 15/85 to 70/30. In some embodiments, the A/B weight ratio is in a range from 15/85 to 70/30, from 20/80 to 70/30, from 25/75 to 70/30, from 30/70 to 70/30, from 35/65 to 70/30, from 40/60 to 70/30, from 45/55 to 70/30, from 50/50 to 70/30, from 55/45 to 70/30, from 60/40 to 70/30, from 65/35 to 70/30, from 15/85 to 50/50, from 20/80 to 50/50, from 25/75 to 50/50, from 30/70 to 50/50, from 35/65 to 50/50, from 40/60 to 50/50, from 45/55 to 50/50, from 15/85 to 30/70, from 20/80 to 30/70, from 25/75 to 30/70, and any and all ranges and subranges therebetween.

In some embodiments, the particles of elements A and B and the carbonaceous material are present at a weight ratio (hereinafter, (A+B)/carbon weight ratio) of 5/95 or greater. In some embodiments, the elements A and B and the carbonaceous material are present at a weight ratio, (A+B)/carbon weight ratio, of less than 25/75. In some embodiments, the (A+B)/carbon weight ratio has a value in a range from 5/95 to 20/80. In some embodiments, the (A+B)/carbon weight ratio has a value in a range from 5/95 to 20/80, from 7/93 to 20/80, from 10/90 to 20/80, from 12/88 to 20/80, from 15/85 to 20/80, from 5/95 to 15/85, from 7/93 to 15/85, from 10/90 to 15/85, from 12/88 to 15/85, from 5/95 to 10/90, from 7/93 to 10/90, and any and all ranges and subranges therebetween.

In some embodiments, particles of element A and particles of element B are present at a total volume (hereinafter Vol_{(A+B)}) in a range from 1% to 15% in the coating. In some embodiments, Vol_{(A+B)} is in a range from 1% to 25%, from 1% to 20%, from 1% to 15%, from 1% to 12.5%, from 1% to 10%, from 2.5% to 20%, from 2.5% to 15%, from 2.5% to 10%, from 5% to 25%, from 5% to 20%, from 5% to 15%, from 5% to 10%, from 7.5% to 25%, from 7.5% to 20%, from 7.5% to 15%, from 7.5% to 10%, from 10% to 25%, from 10% to 20%, from 10% to 15%, and any and all ranges and subranges therebetween.

In some embodiments, element A, element B, or both may be in a form of nanoparticles in the coating distributed in the matrix of the carbonaceous material. In such embodiments, the nanoparticles may have an average particle size (D50) in a range from 20 nm to 80 nm. In some embodiments, the average particle size is in a range from 10 nm to 200 nm, from 10 nm to 175 nm, from 10 nm to 150 nm, from 10 nm to 125 nm, from 10 nm to 100 nm, from 10 nm to 80 nm, from 10 nm to 60 nm, from 10 nm to 50 nm, from 15 nm to 200 nm, from 15 nm to 175 nm, from 15 nm to 150 nm, from 15 nm to 125 nm, from 15 nm to 100 nm, from 15 nm to 80 nm, from 15 nm to 60 nm, from 15 nm to 50 nm, from 20 nm to 200 nm, from 20 nm to 175 nm, from 20 nm to 150 nm, from 20 nm to 125 nm, from 20 nm to 100 nm, from 20 nm to 80 nm, from 20 nm to 60 nm, from 20 nm to 50 nm, from 25 nm to 200 nm, from 25 nm to 175 nm, from 25 nm to 150 nm, from 25 nm to 125 nm, from 25 nm to 100 nm, from 25 nm to 80 nm, from 25 nm to 60 nm, and any and all ranges and subranges therebetween.

In some embodiments, the coating has a thickness in a range from 0.1 μm to 50 μm. In some embodiments, the coating has a thickness in a range from 0.05 μm to 100 μm, from 0.1 μm to 100 μm, from 0.25 μm to 100 μm, from 0.5 μm to 100 μm, from 1 μm to 100 μm, from 2.5 μm to 100 μm, from 5 μm to 100 μm, from 10 μm to 100 μm, from 0.05 μm to 75 μm, from 0.1 μm to 75 μm, from 0.25 μm to 75 μm, from 0.5 μm to 75 μm, from 1 μm to 75 μm, from 2.5 μm to 75 μm, from 5 μm to 75 μm, from 10 μm to 75 μm, from 0.1 μm to 50 μm, from 0.25 μm to 50 μm, from 0.5 μm to 50 μm, from 1 μm to 50 μm, from 2.5 μm to 50 μm, from 5 μm to 50 μm, from 10 μm to 50 μm, from 0.05 μm to 25 μm, from 0.1 μm to 25 μm, from 0.25 μm to 25 μm, from 0.5 μm to 25 μm, from 1 μm to 25 μm, from 2.5 μm to 25 μm, from 5 μm to 25 μm, from 10 μm to 25 μm, from 0.05 μm to 20 μm, from 0.1 μm to 20 μm, from 0.25 μm to 20 μm, from 0.5 μm to 20 μm, from 1 μm to 20 μm, from 2.5 μm to 20 μm, from 5 μm to 20 μm, from 10 μm to 20 μm, from 0.05 μm to 10 μm, from 0.1 μm to 10 μm, from 0.25 μm to 10 μm, from 0.5 μm to 10 μm, from 1 μm to 10 μm, from 2.5 μm to 10 μm, or from 5 μm to 10 μm.

In some embodiments, the coating may further comprise a binder. The binder may be a polymer. In some embodiments, the binder comprises at least one selected from the group consisting of polyvinylidene fluoride (PVDF), polytetrafluoroethylene (PTFE), vinylidene fluoride/hexafluoropropylene copolymers, polyimide, polyethylene, polyester, polyacrylonitrile, polymethyl methacrylate, carboxymethyl cellulose/styrene-butadiene rubber (CMC/SBR) copolymers, styrene butadiene rubber (SBR) and mixtures thereof. In some embodiments, the binder is present at a weight percentage in a range from 1% to 20% in the coating. In some embodiments, the binder is present at a weight percentage in a range from 1% to 15%, from 1% to 10%, from 1% to 7.5%, from 1% to 5%, from 2% to 15%, from 2% to 10%, from 2% to 7.5%, from 2% to 5%, from 2.5% to 15%, from 2.5% to 10%, from 1.5% to 7.5%, from 2.5% to 5%, and any and all ranges and subranges therebetween in the coating.

In some embodiments, the coating may comprise a dispersant. In some embodiments, the dispersant may be at least one selected from the group consisting of polyvinylpyrrolidone (PVP), ethyl cellulose, polyethylene glycol and mixtures thereof. In some embodiments, the dispersant is present at a weight percentage in a range from 0.01% to 5% in the coating. In some embodiments, the dispersant is present at a weight percentage in a range from 0.01% to 10%, from 0.01% to 7.5%, from 0.01% to 5%, from 0.01% to 2.5%, from 0.01% to 1%, from 0.01% to 0.5%, from 0.01% to 0.25%, from 0.02% to 10%, from 0.02% to 7.5%, from 0.02% to 5%, from 0.02% to 2.5%, from 0.02% to 1%, from 0.02% to 0.5%, from 0.02% to 0.25%, 0.05% to 10%, from 0.05% to 7.5%, from 0.05% to 5%, from 0.05% to 2.5%, from 0.05% to 1%, from 0.05% to 0.5%, from 0.05% to 0.25%, 0.1% to 10%, from 0.1% to 7.5%, from 0.1% to 5%, from 0.1% to 2.5%, from 0.1% to 1%, from 0.1% to 0.5%, from 0.1% to 0.25%, and any and all ranges and subranges therebetween in the coating.

The present disclosure also provides a composition for preparing the coating. The composition may include a plurality of particles of element A, a plurality of particles of element B, a carbonaceous material, and a binder. In some embodiments, the composition may further include a solvent and/or a dispersant in a form of slurry, paste or dough-like mixture. In some embodiments, the particles of elements A and B and the carbonaceous material are dispersed in a mixture comprising the solvent, the dispersant and the binder.

In some embodiments the coating may be prepared from the composition/mixture. The method may include: (i) mixing a plurality of particles of element A, a plurality of particles of element B, a carbonaceous material, a binder, a solvent, and a dispersant into a mixture; (ii) coating the mixture onto a substrate, and (iii) drying the mixture coated on the substrate, thus forming a coating comprising the particles of element A and element B uniformly distributed in the matrix of the carbonaceous material. In some embodiments, the method further includes calendaring the coated substrate during or after drying the mixture coated on the substrate to ensure an even surface of the coating.

In some embodiments, the solvent, dispersant, element A, element B and binder are present at a weight ratio of a first total weight of solvent and dispersant to a second total weight of binder, elements A and B in a range from 1:9 to 1:10 in the mixture.

In some embodiments, the mixture coated on the substrate is dried in air or an inert gas.

In some embodiments, the mixture coated on the substrate is dried at temperature in a range from 80° C. to 130° C. for a period from 8 hours to 48 hours.

In some embodiments, the mixture coated on the substrate is further dried under vacuum at a temperature in a range from 60° C. to 120° C. for a period in a range from 8 hours to 48 hours.

In one aspect, this disclosure provides an electrochemical device, such as an all-solid state battery (ASSB) comprising an anode with the coating as described herein. The electrochemical device may include a cathode layer, an inorganic solid electrolyte layer, the coating, and an anode layer, wherein the coating may act as an interlayer between the solid electrolyte layer and the anode layer. In some embodiments, the anode layer comprises an anode current collector. In some embodiments, the anode layer comprises an anode current collector and an anode active material layer. In some embodiments, the anode active material layer comprises lithium metal or a lithium alloy. In some embodiments, the anode active material layer is formed either before or after the first charge of the electrochemical device, such as ASSB.

In some embodiments, the inorganic solid electrolyte layer comprises an oxide-based solid electrolyte, a sulfide-based solid electrolyte, or both. In some embodiments, the inorganic solid electrolyte layer is materially different from an organic solid or semi-solid electrolyte, which uses polymer and salt as the main components.

In some embodiments, the oxide-based solid electrolyte comprises at least one selected from the group consisting of Li_{1+x+y}AlₓTi₂₋ₓSi_{y}P_{3-y}O₁₂ (0<x<2, 0≤y<3), BaTiO₃, Pb(ZrₓTi₁₋ₓ)O₃ (PZT, 0≤a≤1), Pb₁₋ₓLaₓZr_{1-y}Ti_{y}O₃(PLZT) (0≤x<1, 0≤y<1), Pb(Mg_{1/3}Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(AlₐGa₁₋ₐ)ₓ(Ti_{b}Ge_{1-b})₂₋ₓSi_{y}P_{3-y}O₁₂ (0≤x≤1, 0≤y≤1, 0≤a≤1, and 0≤b≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is at least one selected from the group consisting of Te, Nb, and Zr, x is an integer of 1 to 10), and Li₃₊ₓLa₃Zr₂₋ₐMₐO₁₂, wherein M is at least one selected from Ga, W, Nb, Ta, and Al, 0<a<2, x is an integer of 1 to 10.

In some embodiments, the sulfide-based solid electrolyte comprises at least one selected from Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, and Z is one selected from Ge, Zn and Ga), Li₂S—GeS₂, Li₂S—SiS₂—Li₃PO₄, Li₂S—SiS₂—LiₚMO_{q} (where p and q are each a positive number, and M is one selected from P, Si, Ge, B, Al, Ga, and In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

In some embodiments, the cathode comprises at least one selected from the group consisting of LiFePO₄, LiₓMO₂, LiₓNi_{1-y-z}CO_{y}M1_{z}O₂ and LiₓNi_{1-y-z}Mn_{y}M2_{z}O₂, wherein Mis at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0≤z≤0.5.

In some embodiments, the electrochemical device exhibits a capacity retention rate of at least 94% after 20 cycles at a discharge rate of 0.33C.

In some embodiments, the electrochemical device exhibits a specific capacity of at least 160 mAh·g⁻¹ after 20 cycles at a discharge rate of 0.33C.

In some embodiments, the electrochemical device is a battery or a cell of a battery. In some embodiments, the electrochemical device is an all-solid-state battery (ASSB).

In some embodiments, a cell comprising an anode coating as described herein may reduce the overall cell resistance by no less than 20%, no less than 25%, no less than 30%, no less than 35%, no less than 40%, no less than 45%, no less than 50%, no less than 55%, no less than 60%, or no less than 65% in comparison that that of a cell comprising Ag/carbon composite as the anode coating.

In some embodiments, a cell comprising an anode coating as described herein may reduce the charging overpotential by no less than 20%, no less than 25%, no less than 30%, no less than 35%, no less than 40%, no less than 45%, no less than 50%, no less than 55%, no less than 60%, no less than 65%, or no less than 70% at a C rate in a range from 1C to 5.5C in comparison to that of a cell comprising Ag/carbon composite as an anode coating or protective layer at the same C rate. In some embodiments, the C-rate is in a range from 5.5C to 6C, from 5.5 C to 7C, from 5.5 C to 8C, from 5.5 C to 9C, or from 5.5 C to 10C.

In some embodiments, the coating comprises Cu as element A and Zn as element B with a weight ratio of Cu to Zn of 3:7 and the weight ratio of Cu and Zn to the carbonaceous material is 5:95 and wherein the coating has a thickness of around 15-25 μm.

The disclosure will be better understood by reference to the Experimental Details which follow, but those skilled in the art will readily appreciate that the specific experiments detailed are only illustrative and are not meant to limit the disclosure as described herein, which is defined by the claims which follow thereafter.

### Examples

Preparation of Anode with Coatings

TABLE 1
Compositions of anode coatings

| | | | A/B/carbon black |
|---|---|---|---|
| Examples | Element A | Element B | weight ratio |
| Ref. Ex. | Ag | None | 25/0/75 |
| Comp. Ex. 1 | Zn | None | 25/0/75 |
| Comp. Ex. 2 | None | Cu | 0/25/75 |
| Comp. Ex. 3 | None | None | 0/0/100 |
| Ex. 1 | Zn | Cu | 7.5/17.5/75 |
| Ex. 2 | Zn | Cu | 17.5/7.5/75 |
| Ex. 3 | Zn | Cu | 12.5/12.5/75 |
| Ex. 4 | Zn | Cu | 1.5/3.5/95 |
| Ex. 5 | Zn | Cu | 3/7/90 |
| Ex. 6 | Zn | Cu | 6/14/80 |

Nanoparticles of metal or metals with an average particle size (D50) of 40-60 nm and carbon black powder in a certain weight ratio as shown in Table 1 were mixed with N-methylpyrrolidone (NMP) (Sigma-Aldrich), which contains 7 wt % of polyvinylidene fluoride (PVDF, Solef) as binder. Note that 7 wt % binder is based on a total weight of a dried coating excluding solvent. N-methylpyrrolidone was slowly added under constant stirring using a mixer (Thinky Corporation, AR-100), obtaining an anode slurry.

The anode slurry was then coated on a 10 μm thick SUS (stainless steel) foil as an anode current collector using a bar-coating method and dried in the convection oven at 80° C. for 20 min followed by a vacuum dry at 120° C. for 12 h, thereby obtaining an anode layer comprising a coating on the anode current collector. The average thickness of the coating layer was 15±2 μm. Reference Example (Ref. Ex.), Comparative Example 1 (Comp. Ex. 1), Comparative Example 2 (Comp. Ex. 2), Comparative Example 3 (Comp. Ex. 3) of various anode coatings were also prepared by following the same method but following the compositions in Table 1.

### Battery Assembly and Test

TABLE 2
Specific discharge capacity of batteries comprising anode coatings

| | Discharge | Discharge | Discharge |
|---|---|---|---|
| | capacity at | capacity at | capacity at |
| Example No. | 0.33 C (1^{st}) | 1 C | 0.33 C (2^{nd}) |
| Ref. Ex. | 186.9 | 171.4 | 198.8 |
| Comp. Ex.1 | 179.5 | 132.7 | 188.1 |
| Comp. Ex. 2 | 174.4 | 100.9 | 169.6 |
| Comp. Ex. 3 | 189.1 | 171.2 | 201.3 |
| Ex. 1 | 173.7 | 71.7 | 183.2 |
| Ex. 2 | 163.3 | 70.4 | 179.4 |
| Ex. 3 | 159.1 | 41.5 | 179.7 |
| Ex. 4 | 184.5 | 147.3 | 189.6 |
| Ex. 5 | 194.2 | 177.5 | 205.5 |
| Ex. 6 | 194.5 | 172.4 | 197.5 |

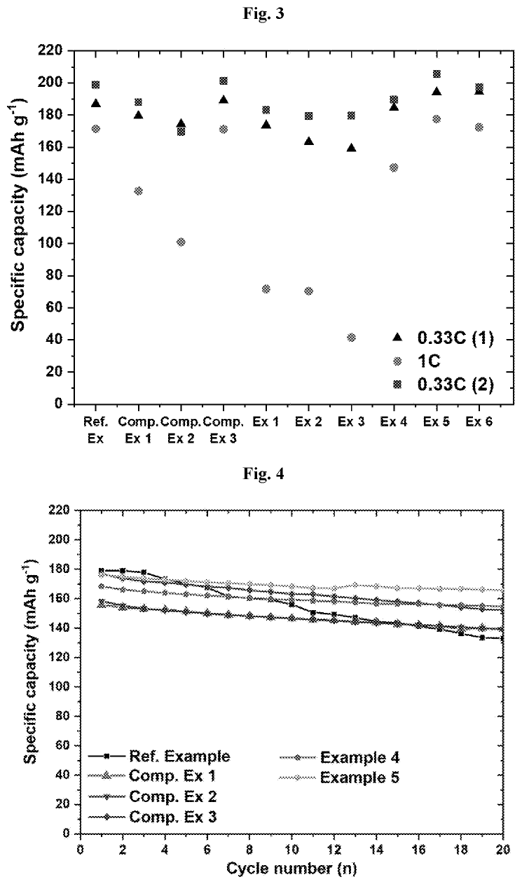

Batteries comprising the coated anodes, an NCA cathode with at least 80 wt % cathode active material, and an Argyrodite-type solid electrolyte as a solid electrolyte layer were assembled. The battery tests were performed with two consecutive steps. First, the rate capability was tested at a constant charge rate of 0.1C during the whole test followed by a discharge rate of 0.33C, 1C and 0.33C sequentially. The specific capacity results are shown in Table 2 and FIG. 3.

Second, the cycle performance tests were conducted between a voltage window between 2.5 V and 4.2 V (vs. Li/Li⁺) under 0.33C/0.33C continuously at 45° C. All the cells were operated under 4 MPa during the whole test procedure. The specific capacity results for Reference Example, Comparative Examples 1 through 3 and Examples 4 and 5 are shown in FIG. 4.

As shown in FIG. 3, Examples 1 through 3 shared the same (A+B)/carbon weight ratio of 25/75 but with varied A/B weight ratios (as well as A/B atomic ratios). Example 1 with an A/B weight ratio of 7.5/17.5 (3/7) shows the highest specific capacity at both 1C and 0.33C.

Even Example 1 is slightly better than Examples 2 and 3, the performance is inferior to Ref. Ex. and Comparative Examples 1 through 3. On the one hand, the results suggest that A/B weight ratio plays a significant role in affecting electrochemical performance. On the other hand, the less desired performance of Examples 1 through 3 may be associated with other factors such as (A+B)/carbon weight ratio to be investigated as follows.

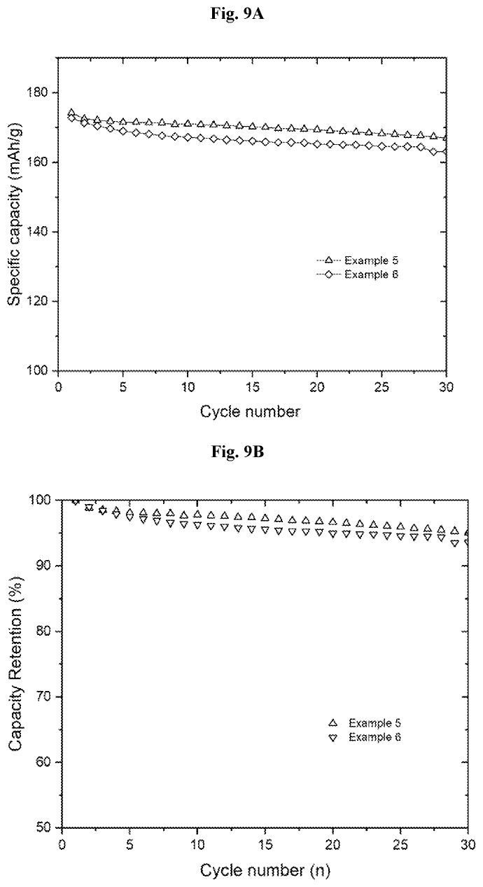

Examples 4 through 6 have the A/B weight ratio fixed at 3/7 but (A+B)/carbon weight ratio varied from 5/95 to 20/80. Example 1 has the same A/B weight ratio with an (A+B)/carbon weight ratio of 25/75. The results demonstrate that the (A+B)/carbon weight ratio also plays a critical role in influencing the electrochemical properties. When the (A+B)/carbon weight ratio is low, for example 5/95 in Example 4, the specific discharge capacity at 0.33C and 1C is 184.5 mAh/g and 147.3 mAh/g, respectively. It is inferior to Examples 5 and 6. When the (A+B)/carbon weight ratio is excessively high, for example 25/75 in Example 1, it exhibits a specific discharge capacity at 0.33 C but much worse specific discharge capacity at 1.0 C in comparison to Examples 5 and 6. As shown in Table 2, FIGS. 9A and 9B, Examples 5 and 6 exhibit a similar specific discharge capacity and similar cycling performance. Thus, only when the (A+B)/carbon weight ratio is in such specified range, for example 10/90 for Example 5 and 20/80 for Example 6, the battery comprising the same can achieve a good discharge capacity and cycling performance in a simultaneous manner.

Without wishing to be bound by any theory, the inferiority at a low (A+B)/carbon weight ratio is probably associated with an insufficient amount of lithium-alloyable (Li-alloyable) element that can be migrated to the anode current collector. When (A+B)/carbon weight ratio is excessively high, nanoparticles of Li-alloyable element, such as Ag and Zn, and nanoparticles of element B, such as Cu, in the anode coating are no longer uniformly distributed in the carbonaceous material, thus less likely to migrate towards the anode current collector.

FIG. 7 is the electrochemical impedance spectroscopy (EIS) result showing that Example 4 possesses an overall cell resistance which is 50% lower than that of Ag/carbon composite coating in Reference Example. The reduced cell resistance implements easier Li migration back and forth inside the cell during cycling. In some embodiments, a cell comprising an anode coating as described herein may reduce the overall cell resistance by no less than 20%, no less than 25%, no less than 30%, no less than 35%, no less than 40%, no less than 45%, no less than 50%, no less than 55%, no less than 60%, or no less than 65% in comparison with that of a cell comprising Ag/carbon composite as anode coating.

As shown in FIG. 4, the cells comprising the anode coating of Reference Example, Comparative Example 3, Example 4 and Example 5 exhibit a specific discharge capacity of 133 mAh/g, 152 mAh/g, 155 mAh/g, and 166 mAh/g, respectively, after 20 cycles with 0.33 C as both the charge and discharge rate. In some embodiments, an electrochemical device comprising an anode coating as disclosed herein exhibits a specific capacity greater than that of an electrochemical device with Ag/carbon nanocomposite as anode coating or carbon as anode coating. In some embodiments, an electrochemical device comprising an anode coating as disclosed herein exhibits a specific capacity of at least 10%, at least 15%, at least 20%, at least 25%, at least 30%, at least 35%, at least 40%, at least 45%, at least 50% or at least 55% greater than that of an electrochemical device with Ag/carbon nanocomposite as anode coating. In some embodiments, an electrochemical device comprising an anode coating as disclosed herein exhibits a specific capacity of at least 5%, at least 10%, at least 15%, at least 20%, at least 25%, at least 30%, at least 35%, at least 40%, or at least 45% greater than that of an electrochemical device with carbon as anode coating.

As also shown in FIG. 4, the cells comprising an anode coating of Reference Ex., Comp. Ex. 3, Ex. 4 and Ex. 5 exhibit a capacity retention rate of 74%, 86%, 92% and 94%, respectively, after 20 cycles with 0.33 C as both charge and discharge rate. Among those cells tested, Ex. 5 with a Zn/Cu/carbon weight ratio of Mar. 7, 1990 exhibits a cycling performance significantly better than Ref. Ex. (Ag/carbon), Comp. Ex. 3 (carbon only), and Ex. 4 (Zn/Cu/carbon with a weight ratio of 1.5/3.5/95). In some embodiments, an electrochemical device comprising an anode coating as disclosed herein exhibits a capacity retention rate higher than that of an electrochemical device comprising Ag/carbon nanocomposite as anode coating or carbon as anode coating. In some embodiments, an electrochemical device comprising an anode coating as disclosed herein exhibits a capacity retention rate of at least 10%, at least 15%, at least 20%, at least 25%, at least 30%, at least 35%, at least 40%, at least 45%, at least 50% or at least 55% greater than that of an electrochemical device with Ag/carbon nanocomposite as anode coating. In some embodiments, an electrochemical device comprising an anode coating as disclosed herein exhibits a capacity retention rate of at least 5%, at least 10%, at least 15%, at least 20%, at least 25%, at least 30%, at least 35%, at least 40%, or at least 45% greater than that of an electrochemical device with carbon as anode coating.

Also based on the data above from Example 5, an electrochemical device comprising a coating with Zn/Cu/carbon weight ratio of Mar. 7, 1990 exhibits a high capacity retention rate. In some embodiments, such an electrochemical device exhibits a capacity retention rate of at least 90% after 20 cycles at a charge and discharge rate of 0.33C at 45° C. and/or exhibits a specific capacity of at least 160 mAh/g after 20 cycles at a discharge rate of 0.33C at 45° C.

Examples 5 and 6 exhibits a similar specific discharge capacity as shown in Table 2 and a comparable cycling performance as shown in FIGS. 9A and 9B.

The influence of A/B weight ratio and alternatively atomic ratio of A/B was further investigated in a more comprehensive manner. The findings demonstrate that A/B weight ratio and A/B atomic ratio play a significant role. Table 3 lists Examples S1 through S10 with (A+B)/carbon weight ratio fixed at 10/90 but varied A/B weight ratios and atomic ratios. S1 through S10 have an A/B weight ratio of 0.5/9.5, 1/9, 1.5/8.5, 2/8, 3/7, 4/6, 5/5, 6/4, 7/3 and 8/2, respectively. S1 through S10 have an A/B atomic ratio of 0.0512, 0.108, 0.172, 0.243, 0.417, 0.648, 0.972, 1.458, 2.268 and 3.888, respectively. S1 and S2 have a relatively low A/B weight ratio and A/B atomic ratio. And the batteries with S1 and S2 exhibit a specific discharge capacity of less than 130 mAh/g at 1C. When the A/B weight ratio and A/B atomic ratio are too high, for example S10, the battery exhibits a specific discharge capacity of less than 120 mAh/g at 1C. Only when the A/B weight ratio is in a range from 1.5/8.5 to 7/3 (for S3 through S9), the batteries can unexpectedly achieve a specific discharge capacity of at least 130 mAh/g at 1C.

Among S3 through S9, only S5 with a Zn/Cu weigh ratio of 3/7 and a Zn/Cu atomic ratio of 0.417 can surprisedly achieve a specific discharge capacity of 194.2 mAh/g at 0.33C and a specific discharge capacity of 177.5 mAh/g at 1C, which are significantly higher than Reference Example (Ag/carbon), and Comp. Ex. 1 (Zn/carbon), Comp. Ex. 2 (Cu/carbon) and Comp. Ex. 3 (carbon only).

TABLE 3
Specific discharge capacity and average CE of batteries
comprising anode coatings of Examples S1 through S10.

| | | | Discharge | Discharge | |
|---|---|---|---|---|---|
| | Zn/Cu/ | Zn/Cu | capacity at | capacity | Average |
| Sample | carbon | atm. | 0.33 C (1^{st}), | at 1 C, | CE, |
| No. | (w/w/w) | ratio | mAh g⁻¹ | mAh g⁻¹ | % |
| Ex. S1 | 0.5/9.5/90 | 0.0512 | 179.2 | 122.0 | 99.2 |
| Ex. S2 | 1/9/90 | 0.108 | 185.6 | 125.9 | 99.5 |
| Ex. S3 | 1.5/8.5/90 | 0.172 | 190.3 | 138.0 | 99.6 |
| Ex. S4 | 2/8/90 | 0.243 | 189.5 | 142.6 | 99.6 |
| Ex. S5 | 3/7/90 | 0.417 | 194.2 | 177.5 | 99.7 |
| Ex. S6 | 4/6/90 | 0.648 | 187.9 | 133.5 | 99.7 |
| Ex. S7 | 5/5/90 | 0.972 | 188.6 | 137.5 | 99.2 |
| Ex. S8 | 6/4/90 | 1.458 | 188.8 | 141.5 | 99.7 |
| Ex. S9 | 7/3/90 | 2.268 | 188.5 | 136.5 | 99.5 |
| Ex. S10 | 8/2/90 | 3.888 | 187.7 | 118.0 | 99.4 |

The influence of (A+B)/carbon weight ratio was also investigated by comparing the data in Table 4 below, wherein the A/B weight ratio is fixed at 3/7.

TABLE 4
Specific discharge capacity and average CE of batteries comprising
anode coatings with different (A + B)/carbon weight ratios

| Sample | Zn/Cu/Carbon | Discharge capacity at | Discharge capacity at |
|---|---|---|---|
| No. | (w/w/w) | 0.33 C (1^{st}), mAh g⁻¹ | 1 C, mAh g⁻¹ |
| Ex. 4 | 1.5/3.5/95 | 184.5 | 147.3 |
| Ex. 5 | 3/7/90 | 194.2 | 177.5 |
| Ex. 6 | 6/14/80 | 194.5 | 172.4 |
| Ex. 1 | 7.5/17.5/75 | 173.7 | 71.7 |

As shown in Table 4, the results clearly provide the importance of (A+B)/carbon weight ratio. Only when element A, element B and carbonaceous material are present at an (A+B)/carbon weight ratio of 10/90, the battery can achieve a desirable discharge capacity and cycling performance. Both A/B weight ratio and (A+B)/carbon weight ratio play a significant role in affecting electrochemical performance.

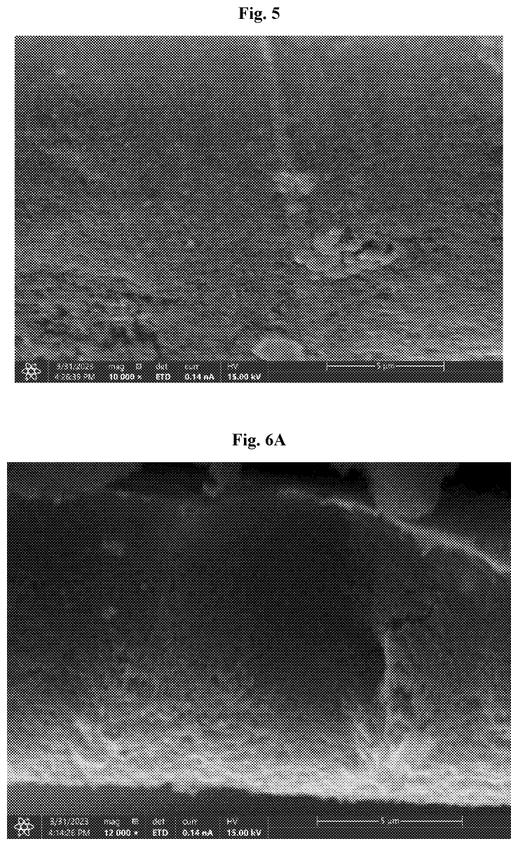

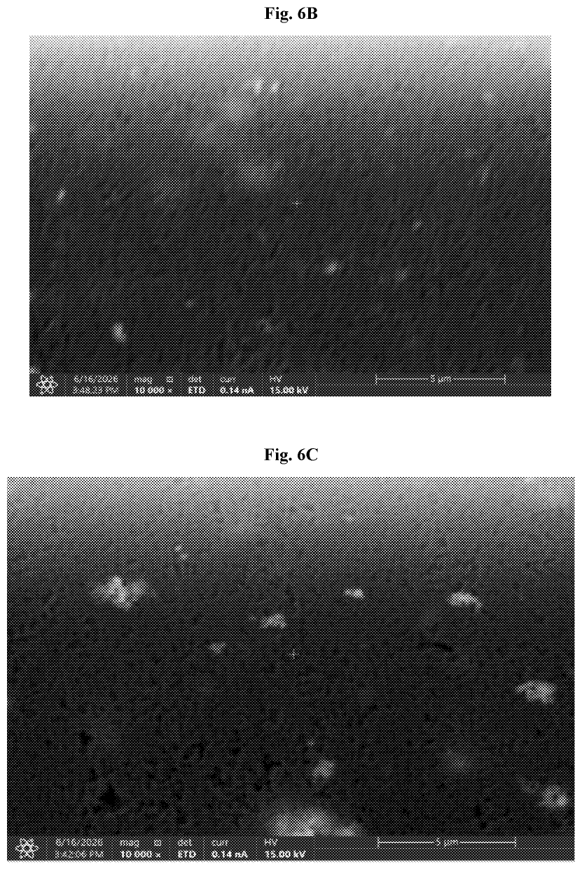

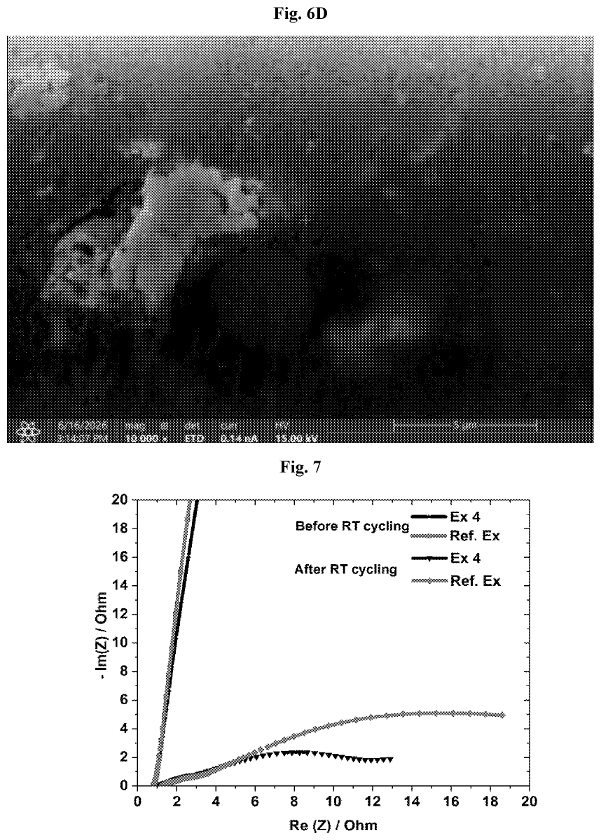

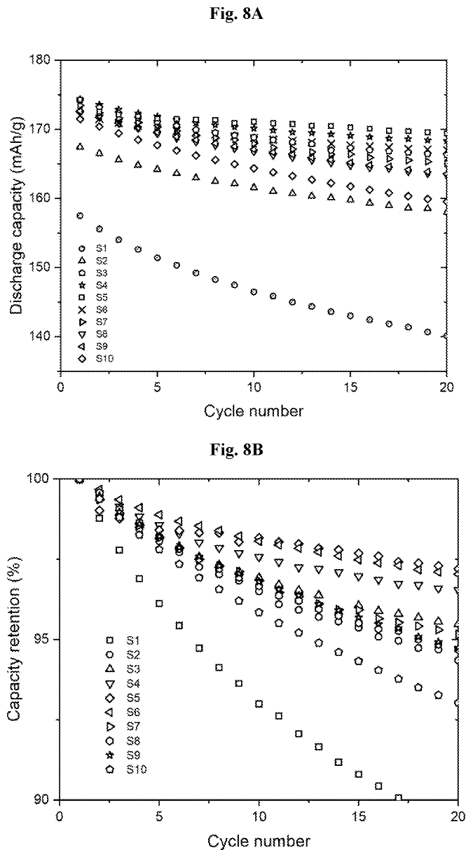

Particle distribution and morphology of the coating may play an important role. FIG. 5 is a cross-section SEM image of the coating of Reference Example (Ag/carbon, 25/75) and shows that some of the Ag nanoparticles (element A) exist as agglomerations. FIGS. 6A, 6B, 6C and 6D show a cross-section SEM image of Example 4 (Zn/Cu/carbon, 1.5/3.5/95), Example 5 (Zn/Cu/carbon, 3/7/90), Example 6 (Zn/Cu/carbon, 6/14/80) and Example 1 (Zn/Cu/carbon, 7.5/17.5/75), respectively. As shown in FIG. 6A and FIG. 6B, nanoparticles of Zn (element A) and nanoparticles of Cu (element B) have an average particle size in a range from 20 nm to 80 and are uniformly distributed in the matrix of the carbonaceous material. No agglomerations are observed. As for Example 6 (Zn/Cu/carbon, 6/14/80) as shown in FIG. 6C, the particle distribution is good overall but with a few small agglomerations. There are severe agglomerations observed in Example 1 (FIG. 6D) similar to Reference Example (FIG. 5). The morphology study of those examples clearly demonstrates that that agglomerations of particles correlate to (A+B)/carbon weight ratio. And an (A+B)/carbon weight ratio with a high value may lead to agglomerations which in turn deteriorate the electrochemical performance of a battery.

Without wishing to be bound by any theory, a coating at a low (A+B)/carbon weight ratio may not provide a sufficient amount of li-alloyable elements that can migrate to the surface of anode current collector. And an excessive amount of (A+B)/carbon weight ratio may lead to formation of agglomeration of particles in the carbonaceous material, which may may affect the migration of Li-alloyable element.

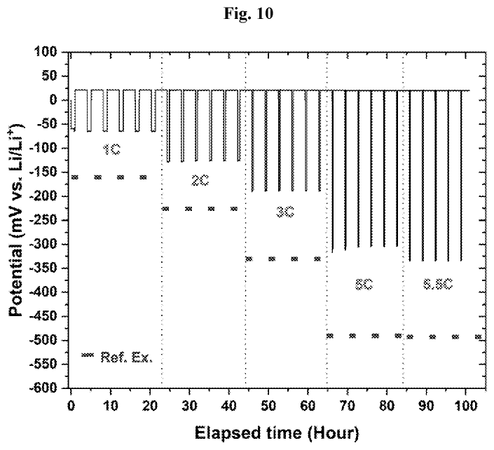

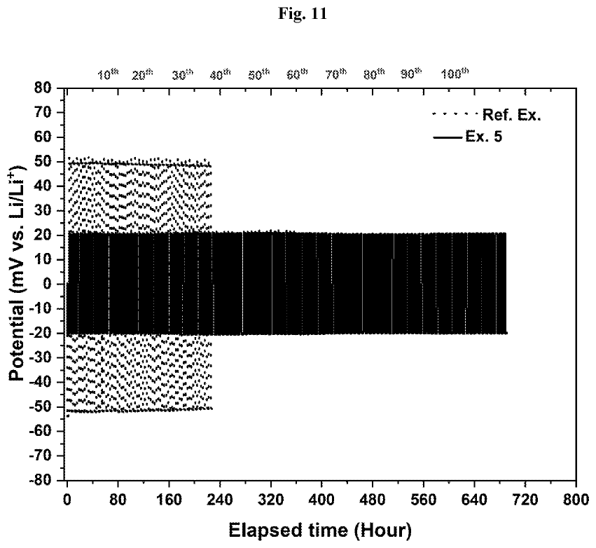

As shown in Table 5, the cell comprising the Zn/Cu anode coating according to example 5 exhibits a significantly reduced overpotential for charging. Also shown in FIG. 10, the cell comprising Example 5 exhibits an overpotential of around −64 mV, around −127 mV, around −189 mV, around −310 mV and around −334 mV for C-rate of 1C, 2C, 3C, 5C and 5.5C, respectively. However, the cell comprising the reference anode coating exhibits an overpotential of around −160 mV, around −225 mV, around −330 mV, around −490 mV and around −493 mV for C-rate of 1C, 2C, 3C, 5C and 5.5C, respectively. In comparison to the reference example, the absolute value of the charging overpotential for Example 5 is reduced by 60%, 46.7%, 42.7%, 36.7% and 32.4% for c-rate of 1C, 2C, 3C, 5C and 5.5C, respectively.

TABLE 5
Absolute overpotentials of reference example and Example 5 in half
cell rate-capability test

| | Absolute | Absolute | Percentage change in |
|---|---|---|---|
| | overpotential | overpotential | comparison to the |
| C rate* | Example 5 | Reference example | reference example |
| 1 C | around 64 mV | around 160 mV | 60% ↓ |
| 2 C | around 127 mV | around 225 mV | 46.7% ↓ |
| 3 C | around 189 mV | around 330 mV | 42.7% ↓ |
| 5 C | around 310 mV | around 490 mV | 36.7% ↓ |
| 5.5 C | around 334 mV | around 493 mV | 32.4% ↓ |

*The half-cell was tested under 1, 2, 3, 5 and 5.5 C (1 C = 170 mAh) for charging (Lithium deposition on the anode side in the full cell) and 6 cycles were given with each C-rate at a temperature of 45 °C

While Reference Example (Ag/carbon composite) exhibited a frequent micro-shortage behavior which can be represented by sudden surge of charge capacity and following coulombic efficiency drop, the cell comprising the Zn/Cu/carbon anode coating exhibited very stable along with the cycling at C/3. Without wishing to be bound by any theory, this phenomenon is potentially attributed to agglomeration and migration of Ag nanoparticles. In the case of Zn/Cu/carbon anode, since the active material content is optimized to minimize the agglomeration and the inactive material is uniformly dispersed without migration, it does not lead to the micro-shortage behavior as the reference does.

### Aspects

In a first aspect, the present disclosure provides a coating comprising:
particles of element A alloyable with lithium;
particles of element B not alloyable with lithium; and
a carbonaceous material,
   wherein the carbonaceous material is present at a volume percentage of at least 50% in the coating, wherein the element A is a metal or metalloid.

In some embodiments, the particles of element A, B or both can be in a form of spherical or near spherical nanoparticles, nanoplatelets, nanowires, or nanotubes in the coating.

In a second aspect according to the first aspect, the element A is capable of forming an alloy with lithium wherein the element lithium has a weight percentage greater than or equal to 4% in the alloy.

In a third aspect according to the first or second aspect, element A comprises at least one selected from the group consisting of Ag, Zn, Ti, Cd, Mg, Al, Ga, Si, Ge, In, Sn, Pb, Bi, and Sb.

In a fourth aspect according to the first or second aspect, the element B has an electric conductivity greater than that of the carbonaceous material and comprises at least one selected from the group consisting of Cu, Mo, Ir, W, Co, Ni, Ru, Fe, Se, Ta, Nb, V, and Zr.

In a fifth aspect according to any preceding aspect, the particles of element A and element B have an average particle size (D50) in a range from 20 nm to 80 nm and are uniformly distributed in a matrix of the carbonaceous material without agglomerations.

In a sixth aspect according to any preceding aspect, the particles of element B exhibit an electrical conductivity greater than that of the particles of element A.

In a seventh aspect according to any preceding aspect, the particles of elements A and B and the carbonaceous material are present at a weight ratio, (A+B)/carbon weight ratio, in a range from 5/95 to 20/80.

In an eighth aspect according to the first or second aspect, the particles of element A and the particles of element B are present at a weight ratio in a range from 15/85 to 70/30 in the coating.

In a nineth aspect according to the first or second aspect, the particles of element A and the particles of element B are present at a weight ratio, A/B weight ratio, in a range from 15/85 to 70/30, and the particles of elements A and B and the carbonaceous material are present at a weight ratio, (A+B)/carbon weight ratio, in a range from 5/95 to 20/80.

In a tenth aspect according to the nineth aspect, the A/B weight ratio has a value of 30/70.

In an eleventh aspect according to the nineth aspect, the (A+B)/carbon weight ratio has a value in a range from 10/90 to 20/80. In some embodiments, the (A+B)/carbon weight ratio has a value of 10/90.

In a twelfth aspect according to the first or second aspect, the particles of element A and the particles of element B are present at an atomic ratio, A/B atomic ratio, in a range from 0.17 to 2.27, and the elements A and B and the carbonaceous material are present at a weight ratio, (A+B)/carbon weight ratio, in a range from 5/95 to 20/80.

In a thirteenth aspect according to the twelfth aspect, the A/B atomic ratio has a value of about 0.42.

In a fourteenth aspect according to the twelfth aspect, the (A+B)/carbon weight ratio has a value in a range from 10/90 to 20/80.

In some embodiments, the coating has a thickness in a range from 0.1 μm to 50 μm. In some embodiments, the coating further comprises a binder. In some embodiments, the coating comprises a dispersant.

In some embodiments, the present disclosure provides a composition for preparing the coating according to the first or second aspect. In some embodiments, the composition further comprises a solvent. In some embodiments, the composition is in a form of slurry, paste or dough-like mixture.

In some embodiments, the solvent comprises at least one selected from the group consisting of N-methylpyrrolidone (NMP), tetrahydrofuran (THF), ethanol, distilled water, and mixtures thereof. In some embodiments, the solvent is nonaqueous, i.e., substantially free of water. In some embodiments, the dispersant comprises at least one selected from the group consisting of polyvinylpyrrolidone (PVP), ethyl cellulose, polyethylene glycol and mixtures thereof. In some embodiments, the dispersant is present at a weight percentage in a range from 0.01% to 5% in the composition. In some embodiments, the binder comprises at least one selected from the group consisting of polyvinylidene fluoride (PVDF), polytetrafluoroethylene (PTFE), vinylidene fluoride/hexafluoropropylene copolymers, polyimide, polyethylene, polyester, polyacrylonitrile, polymethyl methacrylate, carboxymethyl cellulose/styrene-butadiene rubber (CMC/SBR) copolymers, styrene butadiene rubber (SBR) and mixtures thereof. In some embodiments, the binder is present at a weight percentage in a range from 1% to 20% in the composition. In some embodiments, the carbonaceous material comprises at least one selected from the group consisting of carbon fiber, carbon nanotube, carbon wire, natural graphite, artificial graphite, graphene, carbon black, acetylene black, ketjen black, and mixtures thereof.

In a fifteenth aspect, the present disclosure provides a method for preparing an anode coating, comprising:
a) mixing a plurality of particles of element A, a plurality of particles of element B, a carbonaceous material, a binder, a solvent, and a dispersant into a mixture, wherein element A is a metal or metalloid alloyable with lithium and element B is not alloyable with lithium,
b) coating the mixture onto at least one surface of a substrate,
c) calendaring the coated substrate during or after drying the mixture coated on the substrate and
d) drying the mixture coated on the at least one surface of the substrate, thus forming a coating comprising the particles of elements A and B distributed uniformly distributed in a matrix comprising the carbonaceous material, wherein the carbonaceous material is present at a volume percentage of at least 50% in the coating.

In a sixteenth aspect according to the fifteenth aspect, the mixture further comprises a dispersant comprising at least one selected from the group consisting of polyvinylpyrrolidone (PVP), ethyl cellulose, polyethylene glycol and mixtures thereof, and wherein the dispersant is present at a weight percentage in a range from 0.01% to 5% in the mixture.

In some embodiments, the weight ratio of the solvent and the dispersant to the element A, the element B and the binder is in a range from 1:9 to 1:10.

In some embodiments, the mixture coated on the substrate is dried in an inert gas.

In a seventeenth aspect, the present disclosure provides an electrochemical device comprising the coating according to any of the first through fourteenth aspects disposed on an anode layer. In some embodiments, the anode layer comprises an anode current collector. In some embodiments, the anode layer comprises an anode active material layer which may be formed either before or after first charge of a battery comprising the anode layer. In some embodiments, the anode active material layer comprises an anode active material comprising lithium metal or lithium alloy.

In an eighteenth aspect according to the seventeenth aspect, the electrochemical device further comprises an inorganic solid electrolyte layer. In some embodiments, the inorganic solid electrolyte layer comprises a sulfide-based solid electrolyte comprising at least one selected from the group consisting of Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, and Z is one selected from Ge, Zn and Ga), Li₂S—GeS₂, Li₂S—SiS₂—Li₃PO₄, Li₂S—SiS₂—LiₚMO_{q} (where p and q are each a positive number, and M is one selected from P, Si, Ge, B, Al, Ga, and In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), and mixtures thereof.

In some embodiments, the inorganic solid electrolyte layer comprises an oxide-based solid electrolyte, which comprises at least one selected from the group consisting of Li_{1+x+y}AlₓTi₂₋ₓSi_{y}P_{3-y}O₁₂ (0<x<2, 0<y<3), BaTiO₃, Pb(ZrₓTi₁₋ₓ)O₃ (PZT, 0≤a≤1), Pb₁₋ₓLaₓZr_{1-y}Ti_{y}O₃(PLZT) (0≤x<1, 0≤y<1), Pb(Mg_{1/3}Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃(0<x<2, 0<y<3), LiₓAl_{y}Ti_{z}(PO₄)₃(0<x<2, 0<y<1, 0<z<3), Li_{1+x+y} (AlₐGa₁₋ₐ)ₓ(Ti_{b}Ge_{1-b})₂₋ₓSi_{y}P_{3-y}O₁₂ (0≤x≤10≤y≤1, 0≤a≤1, and 0≤b≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is at least one selected from the group consisting of Te, Nb, and Zr, x is an integer of 1 to 10), Li₃₊ₓLa₃Zr₂₋ₐMₐO₁₂, wherein M is at least one selected from Ga, W, Nb, Ta, and Al, 0<a<2, x is an integer of 1 to 10, and mixtures thereof.

In a nineteenth aspect according to the seventeenth aspect, the electrochemical device exhibits a specific discharge capacity and cycling performance comparable to or better than that of an electrochemical device comprising an anode coating comprising a coating of Ag/carbon nanocomposite or a coating of the carbonaceous material only.

In some embodiments, the electrochemical device exhibits a specific capacity of at least 155 mAh·g⁻¹ after 20 cycles at a discharge rate of 0.33C.

In a twentieth aspect according to the seventeenth aspect, the electrochemical device exhibits a charging overpotential of at least 30% lower than that of an electrochemical device comprising an anode coating comprising a coating of Ag/carbon nanocomposite or a coating of the carbonaceous material.

In some embodiments, the electrochemical device comprises a cathode layer. In some embodiments, the cathode layer comprises a cathode active material. In some embodiments, the cathode active material comprises at least one selected from the group consisting of LiFePO₄, LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0≤z≤0.5.

In some embodiments, the electrochemical device exhibits a capacity retention rate of at least 90% after 20 cycles at a discharge rate of 0.33C.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. A coating, comprising:
particles of an element A alloyable with lithium;
particles of an element B not alloyable with lithium; and
a carbonaceous material,
wherein the carbonaceous material is present at a volume percentage of at least 50% in the coating, and the element A is a metal or metalloid.

2. The coating of claim 1, wherein the element A is capable of forming an alloy with lithium and wherein the element lithium has a weight percentage greater than or equal to 4% in the alloy.

3. The coating of claim 1, wherein the element A is at least one selected from the group consisting of Ag, Zn, Ti, Cd, Mg, Al, Ga, Si, Ge, In, Sn, Pb, Bi, and Sb.

4. The coating of claim 1, wherein the element B has an electric conductivity greater than that of the carbonaceous material and comprises at least one selected from the group consisting of Cu, Mo, Ir, W, Co, Ni, Ru, Fe, Se, Ta, Nb, V, and Zr.

5. The coating of claim 1, wherein the particles of element A and element B have an average particle size (D50) in a range from 20 nm to 80 nm and are uniformly distributed in a matrix of the carbonaceous material without agglomerations.

6. The coating of claim 1, wherein the particles of element B exhibit an electrical conductivity greater than that of the particles of element A.

7. The coating of claim 1, wherein the particles of elements A and B and the carbonaceous material are present at a weight ratio, (A+B)/carbon weight ratio, in a range from 5/95 to 20/80.

8. The coating of claim 1, wherein the particles of element A and the particles of element B are present at a weight ratio in a range from 15/85 to 70/30 in the coating.

9. The coating of claim 1, wherein the particles of element A and the particles of element B are present at a weight ratio, A/B weight ratio, in a range from 15/85 to 70/30, and the particles of elements A and B and the carbonaceous material are present at a weight ratio, (A+B)/carbon weight ratio, in a range from 5/95 to 20/80.

10. The coating of claim 9, wherein the A/B weight ratio has a value of 30/70.

11. The coating of claim 9, wherein the (A+B)/carbon weight ratio has a value in a range from 10/90 to 20/80.

12. The coating of claim 1, wherein the particles of element A and the particles of element B are present at an atomic ratio, A/B atomic ratio, in a range from 0.17 to 2.27, and the elements A and B and the carbonaceous material are present at a weight ratio, (A+B)/carbon weight ratio, in a range from 5/95 to 20/80.

13. The coating of claim 12, wherein the A/B atomic ratio has a value of about 0.42.

14. The coating of claim 12, wherein the (A+B)/carbon weight ratio has a value in a range from 10/90 to 20/80.

15. A method for preparing a coating, comprising:
a) mixing a plurality of particles of element A, a plurality of particles of element B, a carbonaceous material, a binder and a solvent into a mixture, wherein element A is a metal or metalloid alloyable with lithium and element B is not alloyable with lithium,
b) coating the mixture onto at least one surface of a substrate,
c) calendaring the coated substrate during or after drying the mixture coated on the substrate, and
d) drying the mixture coated on the substrate, thus forming a coating comprising the particles of elements A and B uniformly distributed in a matrix comprising the carbonaceous material, wherein the carbonaceous material is present at a volume percentage of at least 50% in the coating.

16. The method of claim 15, wherein the mixture further comprises a dispersant comprising at least one selected from the group consisting of polyvinylpyrrolidone (PVP), ethyl cellulose, polyethylene glycol and mixtures thereof, and wherein the dispersant is present at a weight percentage in a range from 0.01% to 5% in the mixture.

17. An electrochemical device comprising the coating of claim 1 disposed on an anode layer.

18. The electrochemical device of claim 17, wherein the electrochemical device further comprises a sulfide-based solid electrolyte comprising at least one selected from the group consisting of Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, and Z is one selected from Ge, Zn and Ga), Li₂S—GeS₂, Li₂S—SiS₂—Li₃PO₄, Li₂S—SiS₂—LiₚMO_{q} (where p and q are each a positive number, and M is one selected from P, Si, Ge, B, Al, Ga, and In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), and mixtures thereof.

19. The electrochemical device of claim 17, wherein the electrochemical device exhibits a specific discharge capacity and cycling performance comparable to or better than that of an electrochemical device comprising an anode coating comprising a coating of Ag/carbon nanocomposite or a coating of the carbonaceous material only.

20. The electrochemical device of claim 17, wherein the electrochemical device exhibits a charging overpotential of at least 30% lower than that of an electrochemical device comprising an anode coating comprising a coating of Ag/carbon nanocomposite or a coating of the carbonaceous material.
